(19) United States
(12) Patent Application Publication
(10) Pub. No.: US 2003/0163651 A1
(43) Pub. Date: Aug. 28, 2003

(54) Apparatus and method of transferring data from one partition of a partitioned computer system to another

(75) Inventors: Vinit Jain, Austin, TX (US); Jeffrey Paul Messing, Austin, TX (US); Rakesh Sharma, Austin, TX (US); Satya Prakesh Sharma, Austin, TX (US); Venkat Venkatsubra, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/082,417

(22) Filed: Feb. 26, 2002

(51) Int. Cl. G06F 13/00

(52) U.S. Cl. 711/147

(57) ABSTRACT

A method, system and apparatus for transferring data from one partition of a partitioned system to another without using a network are provided. When a first partition needs to transfer data to a second partition, it marks the data, which is located in its part of the system's partitioned memory, as a “read-only” data and indicates so to partitioned system's firmware or hardware. This indication is usually manifested by passing a pointer to the data, as well as the identification of the partition to receive the data to the firmware or hardware. Upon being notified, the firmware or hardware of the partitioned system re-assigns the memory locations containing the data to the second partition and passes the pointer to the second partition. As a measure of (redundant) security, the second partition checks to see whether the data is indeed a “read-only” data. If so, it reads the data, else it does not. After reading the data, it so informs the firmware or hardware so that the memory locations of the data can be re-assigned back to the first partition. Thus, because the data never enters the network, it is transferred with the utmost security.

### BACKGROUND OF THE INVENTION

1. Technical Field

The present invention is directed to a method and apparatus for managing a computer system. More specifically, the present invention is directed to a method and apparatus for transferring data from one partition of a partitioned computer system to another.

2. Description of Related Art

Presently, many computer manufacturers design computer systems with partitioning capability. To partition a computer system is to divide the computer system's resources (i.e., memory devices, processors etc.) into groups; thus, allowing for a plurality of operating systems to be concurrently executing on the computer system.

Partitioning a computer system may be done for a variety of reasons. Firstly, it may be done for consolidation purposes. Clearly consolidating a variety of computer systems into one by running multiple application programs that previously resided on the different computer systems on only one reduces (i) cost of ownership of the system, (ii) system management requirements and (iii) footprint size.

Secondly, partitioning may be done to provide production environment and test environment consistency. This, in turn, may inspire more confidence that an application program that has been tested successfully will perform as expected.

Thirdly, partitioning a computer system may provide increased hardware utilization. For example, when an application program does not scale well across large numbers of processors, running multiple instances of the program on separate smaller partitions may provide better throughput.

Fourthly, partitioning a system may provide application program isolation. When application programs are running on different partitions, they are guaranteed not to interfere with each other. Thus, in the event of a failure in one partition, the other partitions will not be affected. Furthermore, none of the application programs may consume an excessive amount of hardware resources. Consequently, no application programs will be starved out of required hardware resources.

Lastly, partitioning provides increased flexibility of resource allocation. A workload that has resource requirements that vary over a period of time may be managed more easily if it is being run on a partition. That is, the partition may be easily altered to meet the varying demands of the workload.

Currently, if a first partition needs to pass data to a second partition, it has to use the network. Specifically, the data has to travel the TCP/IP stack of the transmitting partition and enters the network. From the network, the data will enter the recipient partition through a network interface, travels up the recipient's TCP/IP stack to be processed. This is a time-consuming and CPU intensive task.

Thus, what is needed is an apparatus and method of passing data from one partition to another without using a network.

### SUMMARY OF THE INVENTION

The present invention provides a method, system and apparatus for transferring data from one partition of a partitioned system to another without using a network. When a first partition needs to transfer data to a second partition, it marks the data, which is located in its part of the system's partitioned memory, as a “read-only” data and indicates so to partitioned system's firmware or hardware. This indication is usually manifested by passing a pointer to the data, as well as the identification of the partition to receive the data to the firmware or hardware. Upon being notified, the firmware or hardware of the partitioned system re-assigns the memory locations containing the data to the second partition and passes the pointer to the second partition. As a measure of (redundant) security, the second partition checks to see whether the data is indeed a “read-only” data. If so, it reads the data, else it does not. After reading the data, it so informs the firmware or hardware so that the memory locations of the data can be re-assigned back to the first partition. Thus, because the data never enters the network, it is transferred with the utmost security.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 illustrates a logically partitioned (LPAR) computer system.

FIG. 5 illustrates a mapping table of resources of an LPAR system.

FIG. 6 illustrates a mapping table of resources after re-assignment of a buffer from a first partition to a second partition.

FIG. 7 is a flow chart of a process that may be used when a partition needs to transfer data to another partition.

FIG. 8 illustrates a flow chart of a process that may be used by a receiving partition.

### DETAILED DESCRIPTION OF THE PREFERRED EMBODIMENT

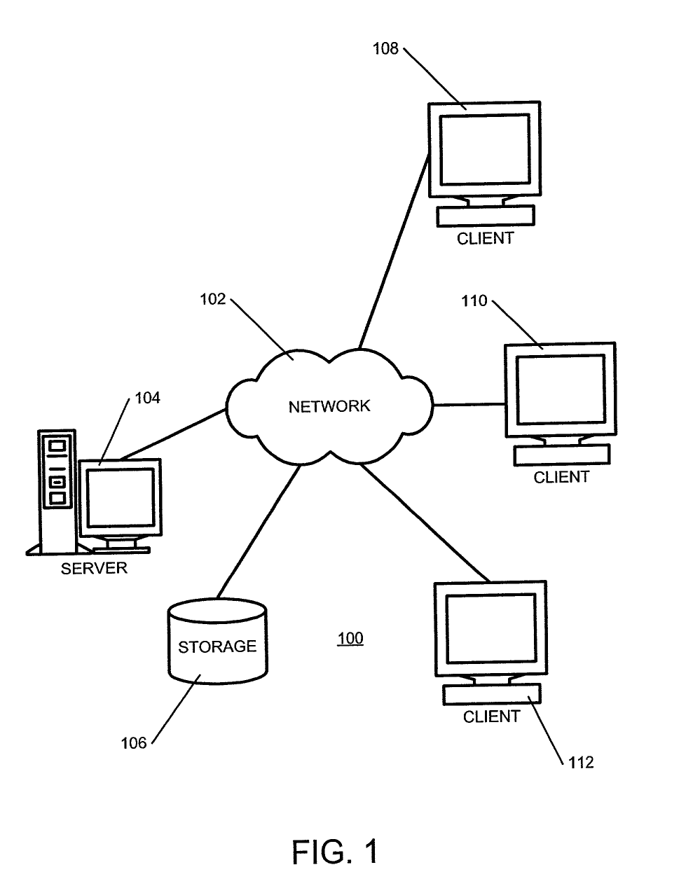

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

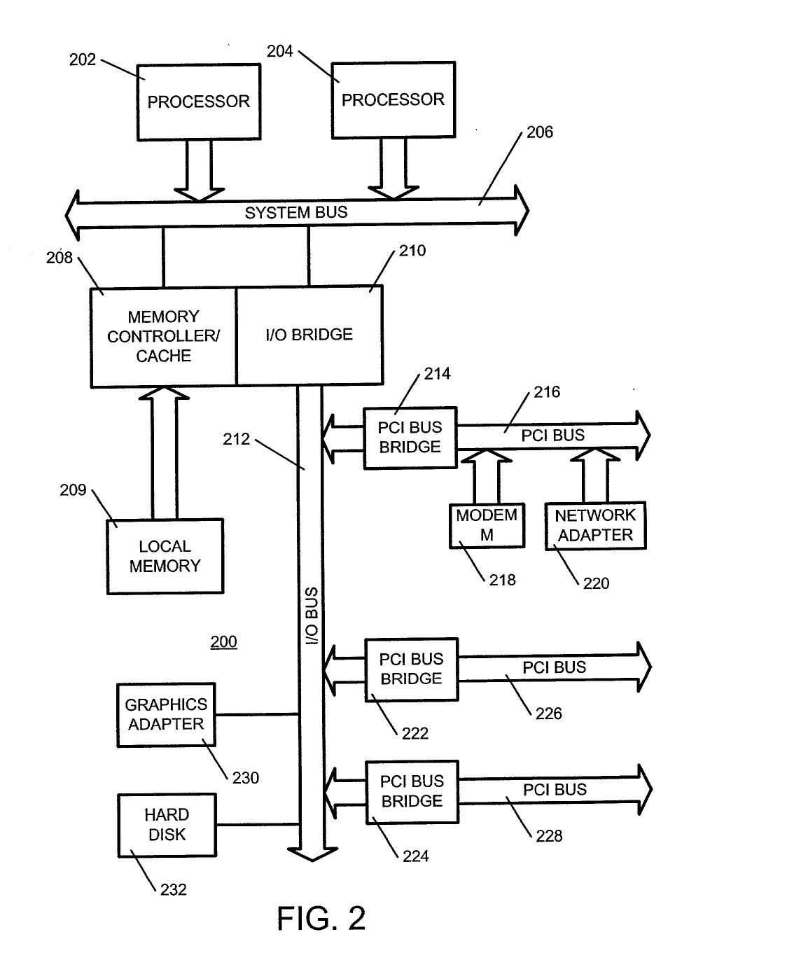

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

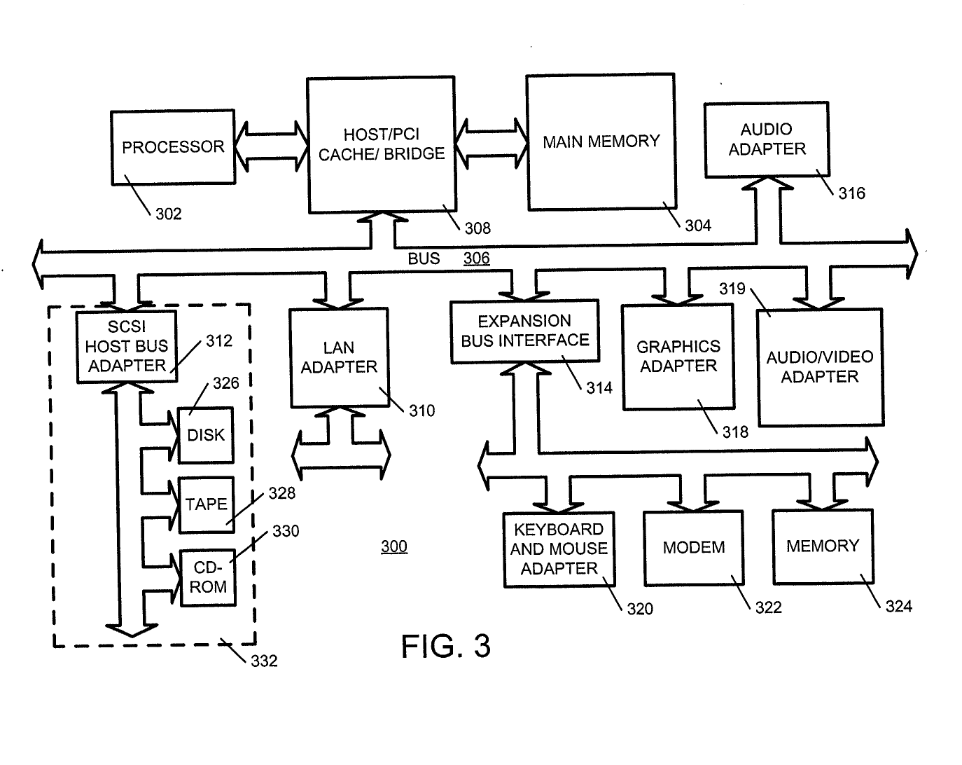

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of allowing data to be passed from one partition of a logically partitioned computer system to another without using a network. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

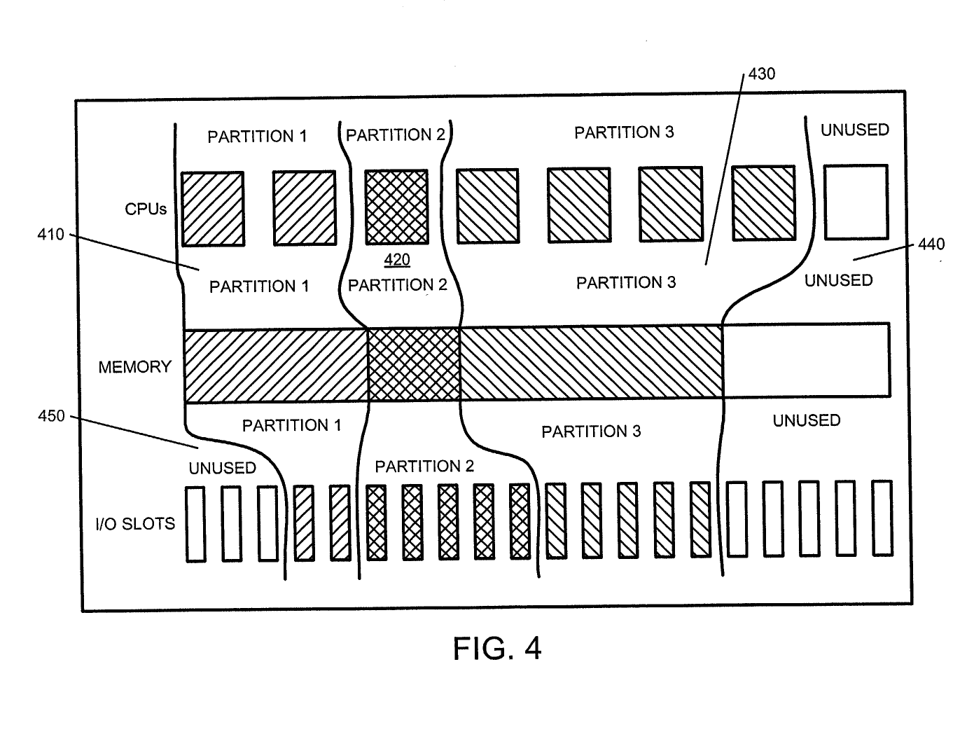

FIG. 4 illustrates a plurality of partitions of a computer system. Partition 1 410 has two (2) processors, two (2) I/O slots and used a percentage of the memory device. Partition 2 420 uses one (1) processor, five (5) I/O slots and also used a smaller percentage of the memory device. Partition 3 430 uses four (4) processors, five (5) I/O slots and uses a larger percentage of the memory device. Areas 440 and 450 of the computer system are not assigned to a partition and are unused. Note that in FIG. 4 only subsets of resources needed to support an operating system are shown.

As shown, when a computer system is partitioned its resources are divided among the partitions. The resources that are not assigned to a partition are not used. More specifically, a resource may either belong to a single partition or not belong to any partition at all. If the resource belongs to a partition, it is known to and is only accessible to that partition. If the resource does not belong to any partition, it is neither known to nor is accessible to any partition. Note that one CPU may be shared by two or more partitions. In that case, the CPU will spend an equal amount of time processing data from the different partitions.

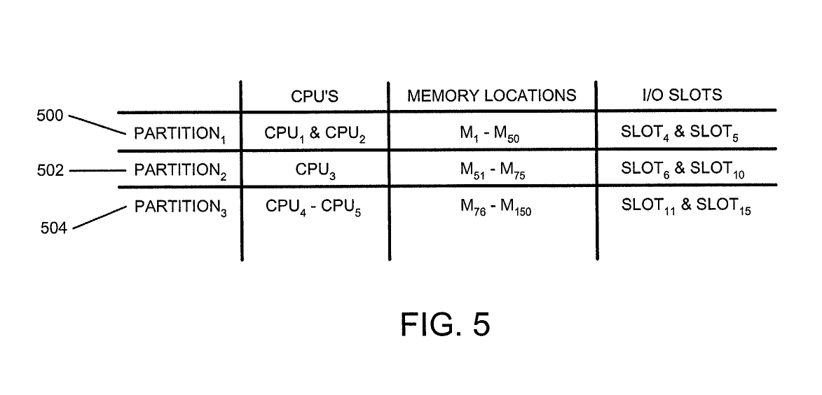

The computer system ensures that the resources assigned to one partition are not used by another partition through a mapping table. FIG. 5 illustrates such table. In FIG. 5, CPU₁ and CPU₂, memory location 1 to memory location 50 (i.e., M₁-M₅₀) and input/output (I/O) slot₄ and slot₅ are mapped to partition₁ 500. Likewise, CPU₃, M₅₁-M₇₅ and I/O slot₆ to slot₁₀ are mapped to partition₂ 502 and CPU₄ to CPU₇, M₇₆-M₁₅₀ and I/O slot₁₁ to I/O slot₁₅ are mapped to partitions 504.

As mentioned before, when a partition of a partitioned system needs to pass a piece of data to another partition of the system, it does so using the network (i.e., the data travels through the TCP/IP stack of the transmitting partition and onto the network, from there it enters the recipient partition, travels through its TCP/IP stack to be processed). This requires quite a bit of processing time and power.

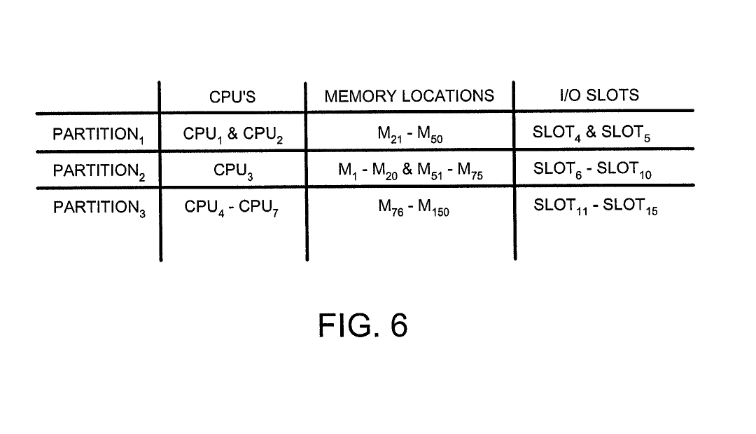

The invention temporarily re-assigns the portion of its memory containing the data to the other partition; thereby reducing the amount of time and work that the CPUs may expend. For example, if the data exists in memory locations M₁ to M₂₀ of partition, that part of the memory will be re-assigned to partition₂ as shown in FIG. 6. Once, partition₂ has finished reading the data, memory locations M₁ to M₂₀ will be re-assigned back to partition₁ (see FIG. 5). Before, assigning the memory locations containing the data to partition₂, partition₁ ensures that the data is not modified by the recipient partition, the transmitting partition marks it a “read only” memory. As a redundant security, before using the data, partition₂ (the recipient partition) ascertains that the memory location containing the data is indeed a “read only” memory. If so, it will use the data; otherwise it will not. Hence the data is transmitted from one partition to another without ever entering the network. Furthermore, since the data never enters the network, it is transmitted with the utmost security.

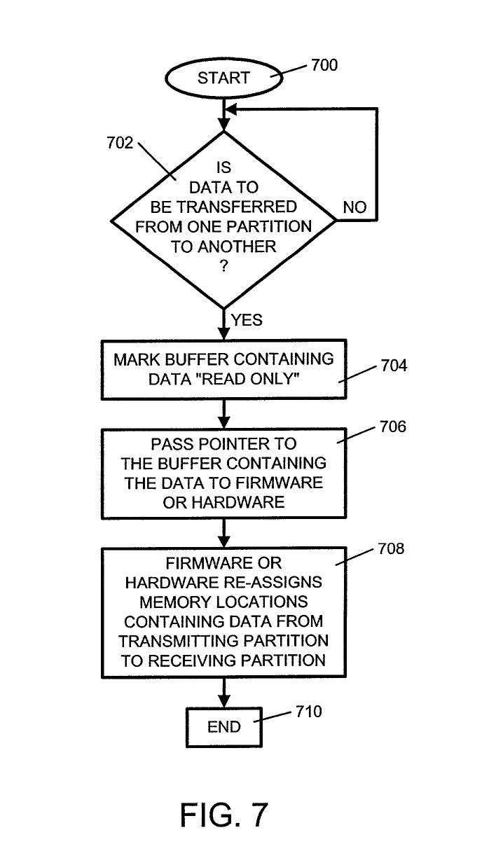

FIG. 7 is a flow chart of a process that may be used when a partition needs to transfer data to another partition. The process starts when a piece of data is to be transferred (steps 700 and 702). Then, the buffer containing the data is marked as a “read-only” buffer before passing the pointer to the buffer to the computer system's firmware or hardware that is going to re-assign the memory locations containing the data to the receiving partition. Of course the identification of the partition to receive the data is also passed to the firmware or hardware. After the firmware or hardware re-assigns the memory location containing the data to the receiving partition, the process ends (steps 704-710).

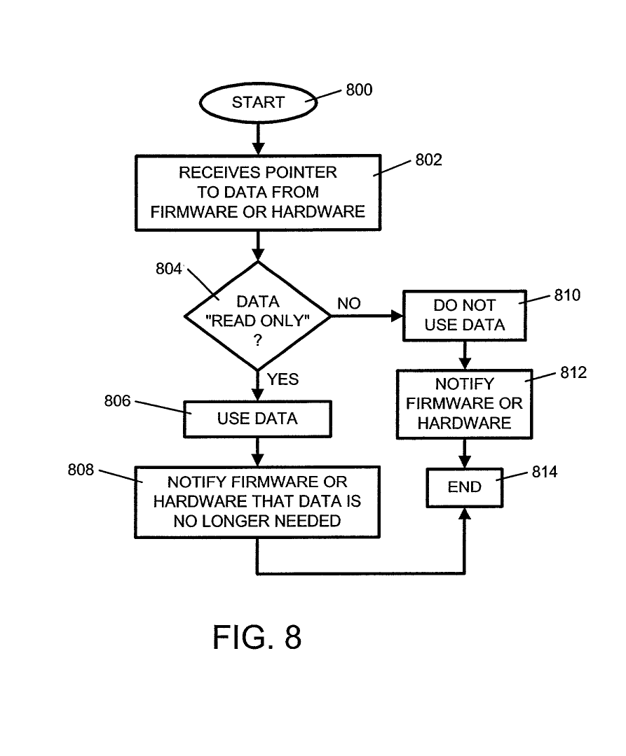

FIG. 8 illustrates a flow chart of a process that may be used by a receiving partition. The process starts as soon as the receiving partition receives the pointer to a buffer containing data from the firmware (steps 800 and 802). A check is then made to ascertain that the buffer containing the data is a “read-only” buffer. If so, the receiving uses the data. Once done, the receiving partition informs the firmware or hardware. The firmware or hardware then assigns the memory locations containing the data back to the transmitting partition and the process ends (steps 804, 806, 808 and 814).

If the buffer containing the data is not a “read-only” buffer, the receiving partition will not use the data and will inform the firmware or hardware that it did not read the data because it was not in a “read-only” buffer. The firmware or hardware will then inform the transmitting partition that the data was not read by the receiving partition and the reason why it was not read and re-assign the memory locations containing the data back to the transmitting partition. At this point, the transmitting partition has the option to attempt retransmission or not.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of transferring data from a first partition of a partitioned computer system to a second partition comprising the steps of:
marking a buffer containing the data as a “read-only” buffer, the buffer being in the first partition; and
passing a pointer to the buffer to the second partition.

2. The method of claim 1 wherein upon passing the pointer to the buffer to the second partition, the buffer is re-assigned to the second partition.

3. The method of claim 2 wherein before reading the data, the second partition ensures that the buffer containing the data is a “read-only” buffer.

4. The method of claim 3 wherein after the second partition reads the data, the buffer is re-assigned back to the first partition.

5. A method of transferring data from a first partition of a partitioned computer system to a second partition comprising the steps of:
marking a buffer containing the data as a “read-only” buffer, the buffer being in the first partition;
passing a pointer to the buffer to the second partition; and
re-assigning the buffer to the second partition.

6. The method of claim 5 wherein after the second partition reads the data, the buffer is re-assigned back to the first partition.

7. A computer program product on a computer readable medium for transferring data from a first partition of a partitioned computer system to a second partition comprising:
code means for marking a buffer containing the data as a “read-only” buffer, the buffer being in the first partition; and
code means for passing a pointer to the buffer to the second partition.

8. The computer program product of claim 7 wherein upon passing the pointer to the buffer to the second partition, the buffer is re-assigned to the second partition.

9. The computer program product of claim 8 wherein before reading the data, the second partition ensures that the buffer containing the data is a “read-only” buffer.

10. The computer program product of claim 9 wherein after the second partition reads the data, the buffer is re-assigned back to the first partition.

11. A computer program product on a computer readable medium for transferring data from a first partition of a partitioned computer system to a second partition comprising:
code means for marking a buffer containing the data as a “read-only” buffer, the buffer being in the first partition;
code means for passing a pointer to the buffer to the second partition; and
code means for re-assigning the buffer to the second partition.

12. The computer program product of claim 11 wherein after the second partition reads the data, the buffer is re-assigned back to the first partition.

13. An apparatus for transferring data from a first partition of a partitioned computer system to a second partition comprising:
means for marking a buffer containing the data as a “read-only” buffer, the buffer being in the first partition; and
means for passing a pointer to the buffer to the second partition.

14. The apparatus of claim 13 wherein upon passing the pointer to the buffer to the second partition, the buffer is re-assigned to the second partition.

15. The apparatus of claim 14 wherein before reading the data, the second partition ensures that the buffer containing the data is a “read-only” buffer.

16. The apparatus of claim 15 wherein after the second partition reads the data, the buffer is re-assigned back to the first partition.

17. An apparatus for of transferring data from a first partition of a partitioned computer system to a second partition comprising:
means for marking a buffer containing the data as a “read-only” buffer, the buffer being in the first partition;
means for passing a pointer to the buffer to the second partition; and
means for re-assigning the buffer to the second partition.

18. The apparatus of claim 17 wherein after the second partition reads the data, the buffer is re-assigned back to the first partition.

19. A computer system being partitioned into a plurality of partitions and being able to transfer data from a first partition to a second comprising:
at least one memory device for storing code data; and
at least one processor for processing the code data to mark a buffer containing the data as a “read-only” buffer, the buffer being in the first partition, and to pass a pointer to the buffer to the second partition.

20. The computer system of claim 19 wherein upon passing the pointer to the buffer to the second partition, the buffer is re-assigned to the second partition.

21. The computer system of claim 20 wherein before reading the data, the second partition ensures that the buffer containing the data is a “read-only” buffer.

22. The computer system of claim 21 wherein after the second partition reads the data, the buffer is re-assigned back to the first partition.

23. A computer system being partitioned into a plurality of partitions and being able to transfer data from a first partition to a second comprising:
at least one memory device for storing code data; and
at least one processor for processing the code data to mark a buffer containing the data as a “read-only” buffer, the buffer being in the first partition, to pass a pointer to the buffer to the second partition, and to re-assign the buffer to the second partition.

24. The computer system of claim 23 wherein after the second partition reads the data, the buffer is re-assigned back to the first partition.

25. A method of transferring data with the utmost security comprising the steps of:
storing the data in a buffer of a first partition of a partitioned computer system;
marking the buffer as a “read-only” buffer; and
passing a pointer to the buffer to a second partition of the system thereby transferring the data the utmost security.

26. The method of claim 25 wherein upon passing the pointer to the buffer to the second partition, the buffer is re-assigned to the second partition.

27. The method of claim 26 wherein before reading the data, the second partition ensures that the buffer containing the data is a “read-only” buffer.

28. The method of claim 27 wherein after the second partition reads the data, the buffer is re-assigned back to the first partition.

29. A computer program product on a computer readable medium for transferring data with the utmost security comprising:
code means for storing the data in a buffer of a first partition of a partitioned computer system;
code means for marking the buffer as a “read-only” buffer; and
code means for passing a pointer to the buffer to a second partition of the system thereby transferring the data the utmost security.

30. The computer program product of claim 29 wherein upon passing the pointer to the buffer to the second partition, the buffer is re-assigned to the second partition.

31. The computer program product of claim 30 wherein before reading the data, the second partition ensures that the buffer containing the data is a “read-only” buffer.

32. The computer program product of claim 31 wherein after the second partition reads the data, the buffer is re-assigned back to the first partition.

33. An apparatus for transferring data with the utmost security comprising:
means for storing the data in a buffer of a first partition of a partitioned computer system;
means for marking the buffer as a “read-only” buffer; and
means for passing a pointer to the buffer to a second partition of the system thereby transferring the data the utmost security.

34. The apparatus of claim 33 wherein upon passing the pointer to the buffer to the second partition, the buffer is re-assigned to the second partition.

35. The apparatus of claim 34 wherein before reading the data, the second partition ensures that the buffer containing the data is a “read-only” buffer.

36. The apparatus of claim 35 wherein after the second partition reads the data, the buffer is re-assigned back to the first partition.

37. A computer system for transferring data with the utmost security, the computer system being divided into partitions, the computer system comprising:
at least one storage device for storing code data; and
at least one processor for processing the code data to store the data in a buffer of a first partition of a partitioned computer system, to mark the buffer as a “read-only” buffer, and to pass a pointer to the buffer to a second partition of the system thereby transferring the data the utmost security.

38. The computer system method of claim 37 wherein upon passing the pointer to the buffer to the second partition, the buffer is re-assigned to the second partition.

39. The computer system of claim 38 wherein before reading the data, the second partition ensures that the buffer containing the data is a “read-only” buffer.

40. The computer system of claim 39 wherein after the second partition reads the data, the buffer is re-assigned back to the first partition.
